(19) United States
(12) Patent Application Publication
(10) Pub. No.: US 2005/0193411 A1
(43) Pub. Date: Sep. 1, 2005

(54) Aggregating local cable spots into national equivalent units

(76) Inventor: Lance T. Funston, Narberth, PA (US)

Correspondence Address: GREGORY J. LAVORGNA;DRINKER BIDDLE & REATH LLP, One Logan Square, 18th & Cherry Streets, Philadelphia, PA, 19103-6996, US

(21) Appl. No.: 10/815,300

(22) Filed: Mar. 31, 2004

Related U.S. Application Data
(60) Provisional application No. 60/549,400, filed on Mar. 1, 2004.

(51) Int. Cl. H04N 7/025; H04H 9/00; H04N 7/16; H04N 7/10

(52) U.S. Cl. 725/36; 725/32; 725/1

(57) ABSTRACT

A method which proportionally allocates a national audience delivery to local commercial spot cable inventory using zone level subscriber counts. The method utilizes national quarter-hour viewing data to assign an impression level for each local spot. These local spots are then combined to calculate a national equivalent impression delivery unit.

### RELATED APPLICATION

This application claims the benefit of provisional application Ser. No. 60/549,400, filed Mar. 1, 2004.

### FIELD OF THE INVENTION

The present invention relates generally to cable television advertising, and particularly to aggregating local spots or advertisements aired on local cable television outlets into national equivalent units, and providing accurate audience delivery measurements for those aggregated units.

### BACKGROUND OF THE INVENTION

Local spots are times for commercial messages set aside by cable television networks for sale to local advertisers. The times that are set aside are determined by the cable networks. Local television outlets, such as local cable systems, are not allowed to choose when local spots will run. Cable networks provide the local cable systems with a published schedule that indicates approximately when the local spots will fall. When a local spot is to run, the cable network transmits special, inaudible “tones,” or signals that automatically start and stop the local operators' commercial playback equipment at the appropriate times. The spots aired during these time periods are local spots. If the local operator does not have any local spots to run, a national spot, preselected and broadcast by the network, will run. In essence, the local spot, if available, pre-empts the preselected national spot during these times.

For example, assume a company, called National Beverage, buys a spot from a national cable network, called Network Sports, for air during the time designated for local spots, say Monday at 8 AM. If no local cable company in the country sells a local advertisement for air on Monday at 8 AM on Network Sports, then the National Beverage spot will run on Network Sports on Monday at 8 AM on every cable system in the country that carries Network Sports. If, however, one local cable company, called Local Guys Cable, sells the airtime to a local advertiser, say Local Carwash, then the National Beverage spot will run on Monday at 8 AM on every cable system in the country that carries Network Sports, except Local Guys Cable. Subscribers to Local Guys Cable will see the Local Carwash spot on Network Sports during that time instead of the National Beverage spot.

Local Guys Cable gets paid for airing an advertisement during the local spot time only if it airs a spot other than the preselected national spot. In other words, if Local Guys Cable is unable to sell the local spot to Local Carwash, or another local advertiser, the National Beverage spot will air and Local Guys Cable loses potential advertising revenue. The potential advertising revenue for local cable systems is large, because each cable network designates two to three minutes per hour for local spots and there are numerous cable networks per cable system. However, there is also a large burden of trying to sell the multitude of local spots. Therefore, there is a market for intermediaries to sell national spots on behalf of local cable systems for air during the time designated for local spots.

For example, Company T, a sales intermediary, induces several national advertisers, including Federal Cola, to purchase a national television schedule that is executed by running local spots on cable systems throughout the U.S. rather than buying a schedule directly from the cable networks. As a result of Company T's efforts, Local Guys Cable will air a spot for Federal Cola during the time designated for local spots, such as the aforementioned Monday at 8 AM on Network Sports. In addition, Local Gals Cable will air a spot for Federal Cola on Tuesday evening on the Network News Channel, and Hometown Boys Cable will air a spot on Wednesday afternoon on the Network Weather Channel.

Focusing on Local Guys Cable, its greatest revenue potential comes from direct local sales, even after accounting for the burden and expense of finding willing local advertisers. However, due to the perishable nature of inventory (it is not possible to sell yesterday's unsold inventory), and the dynamic nature of local demand for commercial time (some days and weeks have bigger advertising demand than others, but the supply of local advertising time is constant), Local Guys Cable frequently does not sell all of its available inventory. Selling any remaining unsold inventory at the last minute at “fire-sale” prices is not a good idea, because that would encourage regular advertisers to wait for the fire sales, ultimately reducing the value of all Local Guys Cable's inventory. Prior to the introduction of a sales intermediary, Local Guys Cable had few options with regard to the local unsold spot time: it could leave the spot unsold and air a national spot selected by the network, or it could run a promotional spot or a public service announcement. Either way, Local Guys Cable would not realize any revenue from the unsold spot. However, if Local Guys Cable runs the Federal Cola spot it received from Company T, it realizes advertising revenue from Company T for its unsold time. Because there is a cost associated with using the intermediary, the revenue Local Guys Cable receives from airing the Federal Cola spot is almost certainly less than it would have received for the Local Carwash spot, but it receives this revenue with less effort, and Local Carwash is unaware of Local Guys Cable's willingness to accept a lower rate for the time. Because of the advantages of this option, cable systems are increasingly opting to fill their unsold inventory through the services of a sales intermediary.

That being the case, advertisers have also learned to use sales intermediaries. When an advertiser decides to purchase time for an advertising campaign through an intermediary, the intermediary prepares a proposal that includes, among other things, the intermediary's estimate (or projection) of viewer “impressions;” that is, the audience each spot will deliver. Because no one can know today with certainty how many viewers a program or a network will deliver a month or even a day from now, the estimates and projections are educated guesses, based on previous performance and recent viewing trends. When an advertiser agrees to spend a budget on the campaign, part of the agreement is the size and composition of the audience delivery that the intermediary will deliver, which is termed the claimed delivery. Advertising agreements are executed before the spots actually run, which is to say, before anyone knows with certainty how many viewers actually will be exposed to the commercials during the campaign. After the campaign has concluded, an analysis is conducted to determine exactly how many viewers were, in fact, exposed to the commercials during the campaign. If that analysis determines that fewer impressions were delivered than were contracted for, the intermediary, through the cable systems, typically runs additional spots to make up the under-delivery. Those additional spots are known as Audience Deficiency Units (ADU).

Historically, the process of determining the impressions delivered was difficult and inaccurate. The process started with each cable system sending notarized paper affidavits of performance at the close of every broadcast month to intermediaries such as Company T, or directly to advertisers such as Local Car Wash. The paper affidavits detailed the days, times and networks on which the spot aired, and the name of the program in which the spot aired. For example, an affidavit from Local Guys Cable for the month of January may detail that a Federal Cola spot ran on Monday, January 5, at 8:00 AM on Network Sports in the North Suburban zone in the program Yoga for Beginners.

If the affidavits were sent to the intermediary, the intermediary extracted data from the affidavits manually, to determine the number of times the spot aired on each network at each cable system. The intermediary would select one “local ad insertion zone” (“zone” for short) as a master zone for the entire system. A zone is one or more physical buildings, called headends, where the networks' signals are received, assigned specific channel numbers, local ads are inserted into each channel and they are amplified and modulated out to subscribers' homes. The intermediary used the master zone to represent the number of times a particular cable system ran the spot in every zone. For example, if the master zone for Local Guys Cable contained 10,000 subscribers and inserted the commercial ten times, then it would be assumed that every zone of Local Guys Cable, including North Suburban Zone, inserted the commercial ten times. The chance that every zone actually inserted the same number of spots as the master zone was exceedingly small, and the lack of precision embodied in this “sample” meant that many national advertisers avoided buying media through an intermediary.

The national Nielsen average daypart rating for each spot would then be applied to each spot to determine the household viewing impressions generated by that spot. A rating is a percentage of the total TV households. Therefore, if a network has a 10 rating, that means that 10 percent of the TV households had a TV set turned on and tuned to the network. If Network Sports averaged a 10 rating for the daypart Mon-Fri 6:00 am-9:00 am in January, the intermediary would apply that average 10 rating to the 10,000 homes in the master zone, and conclude that the spot that Local Guys Cable ran at 8:00 AM on Monday, January 5, delivered 1,000 household impressions (10% of 10,000 homes). The national Nielsen average daypart rating for all dayparts are derived from Nielsen's NTI data, which is national viewing data that Nielsen Research Co. publishes based on information obtained from households with televisions equipped with special meters for monitoring viewing habits. The household impressions for all of the local systems' spots were then aggregated together to create a national delivery profile. This aggregation gave the advertiser an estimate of how many viewers saw their spot nationally. A similar aggregation at the cable system level was used to calculate the amount a given cable system should be paid for airing the spot and to determine whether the claimed delivery was met.

As the number of spots increased, it became difficult for the intermediaries to use the historical procedure to count the spots aired on a monthly basis. Furthermore, the weighted daypart average provided a less than desirable accuracy for reporting data to the advertisers, because the daypart average is merely a gross measurement of average viewership based on a broadly defined time period that corresponds to a commonly understood portion of a day, e.g., M-SU 6 PM-12 M, which is commonly referred to as “prime time” or “nighttime.” Using the example above, if the actual 8:00 AM audience delivered was significantly lower than the 10 rating for the 6:00 AM-9:00 AM average, then the delivered household impressions would have been overstated.

### SUMMARY OF THE INVENTION

The invention encompasses a method for aggregating local commercial spot inventory into national equivalent units and for providing accurate audience delivery measurements using published national quarter-hour viewing data. The method begins with processing affidavits in an electronic format for every local spot aired. The affidavits include information about the airing of the local spots. From that information, an impression delivery for a local spot based on viewing data from a national audience measurement is determined. Based on the impression delivery, the local spot is assigned audience values. The steps of determining an impression delivery and the assigning of audience values are then repeated for additional local spots. The local spots are combined (or aggregated) to form one large unit (a “national equivalent unit”). The same method of aggregating local spots into a single large unit is also carried out at the cable system level, aggregating spots across zones to create a “cable system equivalent unit” that offers comparable reach to a single spot that runs once in every zone in the system. The national equivalent units are used when determining total audience delivery for advertisers for billing purposes; the cable system equivalent units are used when determining total audience delivery for the cable systems for payment purposes. The only difference between the two types of aggregated units is the network universe to which they are aggregated. Therefore, when reference to national equivalent units is made herein, that reference is intended to include cable system equivalent units.

For the national equivalent unit, the method further determines the number of units that were aired on each network, the total household impressions for each unit, and the demo impressions for each unit. This step is then repeated for additional national equivalent units. The national equivalent units and their impression delivery data may then be used to determine a value to the advertiser.

The invention's use of an electronic format to gather and process information regarding airing of spots and of national audience measurements allows for the aggregating of a greater number of local spots, which in turn increases the number of potential advertisers. Many network advertisers will not buy a national equivalent unit unless they can be assured with reasonable certainty that the spot will reach a certain percentage of U.S. cable households. The invention's method of aggregating provides the advertiser the assurance that its spots have, in the aggregate, in fact, reached this percentage.

Furthermore, the invention's use of quarter-hour viewing data, which provides information on viewership in date-specific quarter-hour increments instead of daypart averages, which provides information on viewership based on much larger time increments, results in more accurate assessment of the actual viewing audience that saw the local spot. Greater precision in viewership information provides for a more accurate determination of the value of the spot to the advertiser.

### BRIEF DESCRIPTION OF THE DRAWINGS

For the purpose of illustrating the invention there is shown in the drawings various forms which are presently preferred; it being understood, however, that this invention is not limited to the precise arrangements and instrumentalities particularly shown.

FIG. 1 is a flowchart showing the steps of a method according to the invention that is presently preferred.

FIG. 2 is a flowchart showing preferred steps for determining an impression delivery for a local spot according to the invention.

FIG. 3 is a flowchart showing preferred steps for assigning audience values for a local spot according to the invention.

FIG. 4 is a flowchart showing preferred steps for calculating national equivalent spot data according to the invention.

### DETAILED DESCRIPTION OF THE INVENTION

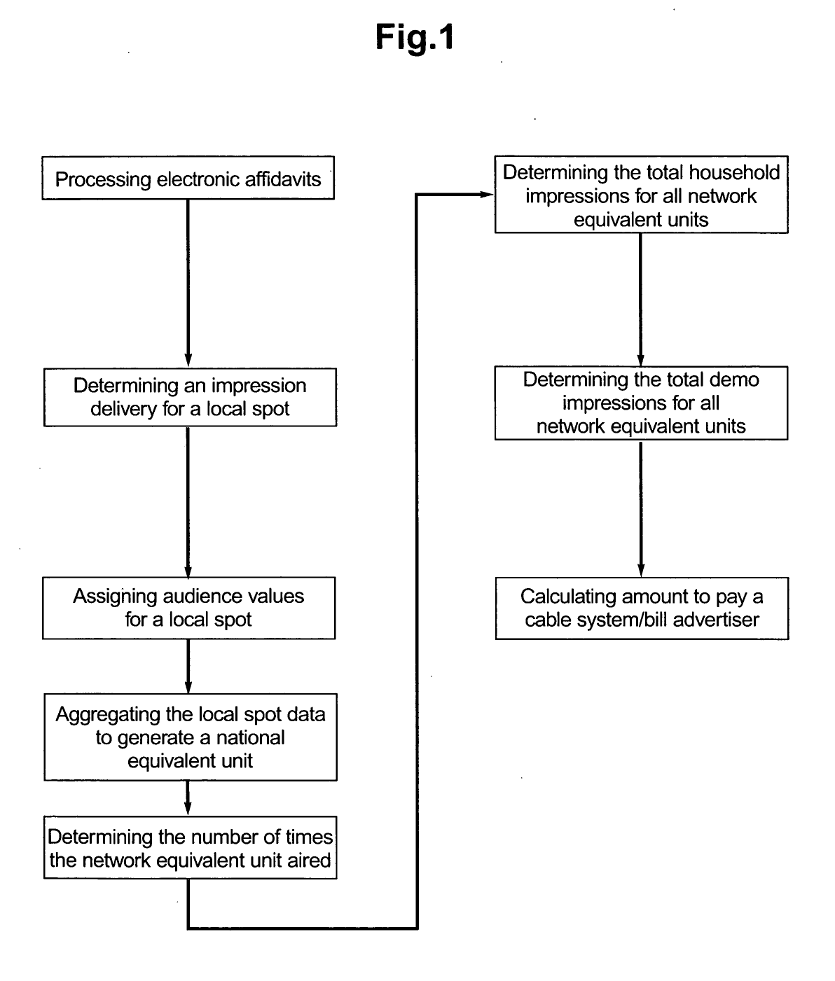

With reference to the drawings, there is shown in FIG. 1 a flowchart depicting the steps of a method according to the invention for aggregating local television commercial spots into national equivalent units and for providing accurate audience delivery measurements using published quarter-hour national viewing data. The preferred use of this method is by intermediaries, as discussed above, who contract with advertisers. The basis of the contract is that the intermediary agrees to work on behalf of the advertisers to get local cable systems to insert the advertisers' spots during time designated for local spots. As part of the contract, the intermediary makes an estimate of how many households and/or members of a demographic group will view the campaign. This estimate is termed the claimed delivery. The claimed delivery is typically based on historical viewing data. It is also dependent on the advertising schedule that the advertiser purchases. The schedule may include one or more networks and it may include one or more dayparts. For example, Federal Cola may order a schedule for its spot of only Midnight to 6 AM on Network Sports. The claimed delivery for this schedule would be markedly different than if Federal Cola had ordered a schedule of 6 AM to Noon and 6 PM to Midnight on Network Sports, Network Weather, and Network News.

Because the contract simply sets forth a claimed delivery, there must be a way to determine the actual delivery so that the advertiser can determine whether the contract was fulfilled and the cable systems can determine how much they are entitled to be paid for delivering the spot or spots. The method of the invention does that.

As illustrated in FIG. 1, the preferred method begins by processing of affidavits in an electronic format for every local spot aired. Affidavits are generated by local cable systems to provide proof of performance, i.e., that the local cable systems aired a particular spot or commercial. As used herein, the term spot includes the term commercial. The affidavits provide details of the spot's airing, such as the exact date, day, time, zone, and network on which the spot aired, as well as the program name during which the spot aired. To repeat the example provided above, an affidavit from Local Guys Cable for the month of January may detail that the Federal Cola spot ran on Monday, January 5 at 8:00 AM on Network Sports in the North Suburban zone during the airing of the program Yoga for Beginners.

Historically, cable systems provided these affidavits in paper format. However, today, the vast majority of the affidavits are provided in electronic format. If the cable system does provide paper affidavits, these affidavits must be scanned into a computer using software, such as optical character recognition (OCR) software, that allows the data to be produced in a uniform, electronically readable format. Even if the cable system provides electronic affidavits, the electronic format of the affidavit data may need to be converted into the same uniform, electronically readable format as noted above.

This conversion into an electronically readable format is the first part of the processing. The second and final part of the processing involves uploading the data from the affidavits (e.g., the date, day, time, zone, and network on which the spot aired) into a database and creating individual records for each local spot for later retrieval and analysis.

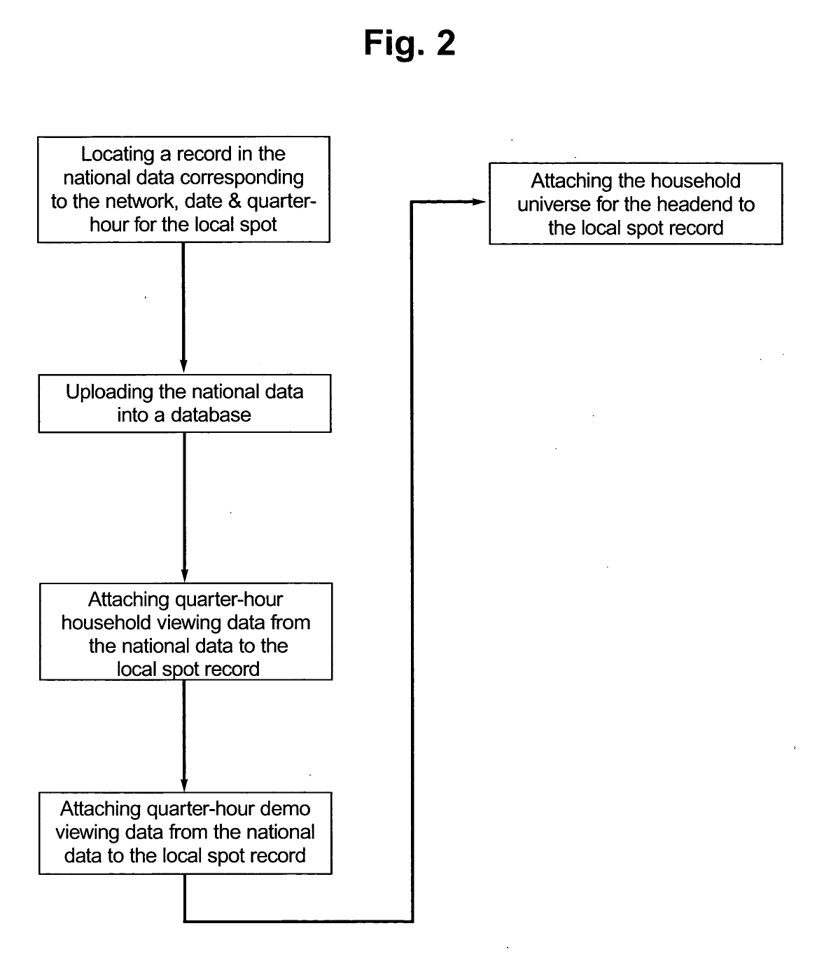

The next step is to determine an impression delivery for the local spots. An impression delivery includes both a household delivery and a demographic (or demo) delivery. A household delivery, when referring to a single spot, is the number of unique U.S. households with at least one television set tuned to a particular network at the time the local spot ran. A demo delivery is the total number of persons in the U.S. that belong to a specific sex-age demographic group, such as Women 25-54 or Men 18-49, that were watching the network at the time the local spot ran. For example, if 500,000 households viewed the Federal Cola spot noted above, the household delivery for that spot would be 500,000, and if 300,000 men between the ages of 18 and 49 viewed the Federal Cola spot, the demo delivery for Men 18-49 for that spot would be 300,000. The preferred manner for carrying out this step is illustrated in FIG. 2.

The impression delivery is based on viewing data, preferably quarter-hour viewing data, from a national audience measurement. The preferred source of the viewing data is the Cable Media Information Tape (CMIT) published weekly by the Nielson Media Research Co. The CMIT contains day-by-day quarter-hour viewing data for the previous week from all reportable cable viewing sources. The viewing data contain both household information and demographic information.

The viewing data from the CMIT are loaded into the same database that the affidavits were loaded into, and are matched with the local spots in the corresponding quarter-hour; that is, the network's national household delivery for the date and quarter-hour is stored with the record for the spot in the database. Likewise, if applicable, the network's national demo delivery for the date and quarter-hour is stored with the record for the spot in the database. For example, if Network Sports had a national household delivery of 500,000 households for the quarter-hour of 8:00-8:15 AM on January 5, and a Federal Cola spot ran on Network Sports during that time on that day, then the national household delivery of 500,000 households would be matched in the database with the record for the Federal Cola spot. The same holds true for the demographic delivery data, such as the 300,000 Men 18-49 who viewed the Federal Cola spot on Network Sports during the quarter-hour of 8:00-8:15 AM on January 5.

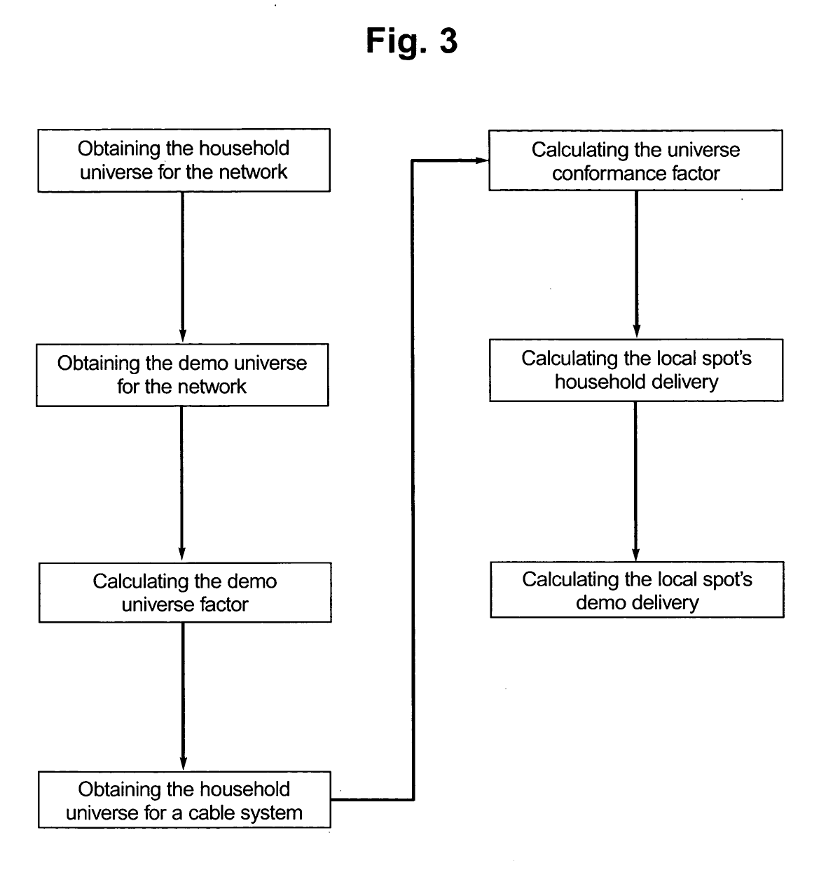

The next step is to assign audience values for the local spots. The preferred manner for carrying out this step is illustrated in FIG. 3. To aid understanding, a running example will be provided after each part of the step.

First, the monthly household universe and the monthly demo universe for the network on which the local spot aired are determined from the national measurement data. A household universe for a network is the total number of households that subscribe to the network. Similarly, a demo universe for a network is the total number of persons within a specific sex-age demographic group that subscribe to the network. For example, Network Sports has a subscriber base for the month of January of 50 million households, which is the monthly household universe. Within those 50 million households, there are 25 million Men 18-49, which is the monthly demo universe for the Men 18-49 demographic.

A demo universe factor is then calculated by dividing the demo universe by the household universe (this factor is calculated at this time for convenience, but is set aside for use later in a subsequent step in the method). In the example, the demo factor is 25 million Men 18-49 (demo universe) divided by 50 million households (household universe), or 0.5.

A household universe for a zone or cable system in which the spot ran is then obtained from the database. For example, a given spot that ran on Local Guys Cable has a household zone universe of 100,000 households. The household universe is stored in the record for the spot in the database for later retrieval.

A universe conformance factor is then calculated by dividing the household zone universe by the household network universe. The universe conformance factor is calculated to provide a means to pro-rate the national delivery down to a zone delivery. In the example, the universe conformance factor for Network Sports on Local Guys Cable is 100,000 households (Local Guys Cable household zone universe) divided by 50 million households (Network Sports household universe), or 0.002.

The spot's household delivery is then calculated by multiplying the network household delivery and the universe conformance factor. After calculating this number, the spot's household delivery is stored in the database. In the example, the Federal Cola spot's household delivery is 500,000 (network household delivery from above) times 0.002 (the universe conformance factor from above), or 1,000.

The spot's demo delivery is then calculated by multiplying the network demo delivery by the universe conformance factor. This number is also stored in the database. In the example, the Federal Cola spot's demo delivery for Men 18-49 is 300,000 (network demo delivery for the demographic group of Men 18-49 from above) times 0.002 (the universe conformance factor from above), or 600.

These steps are then repeated in total for each additional local spot.

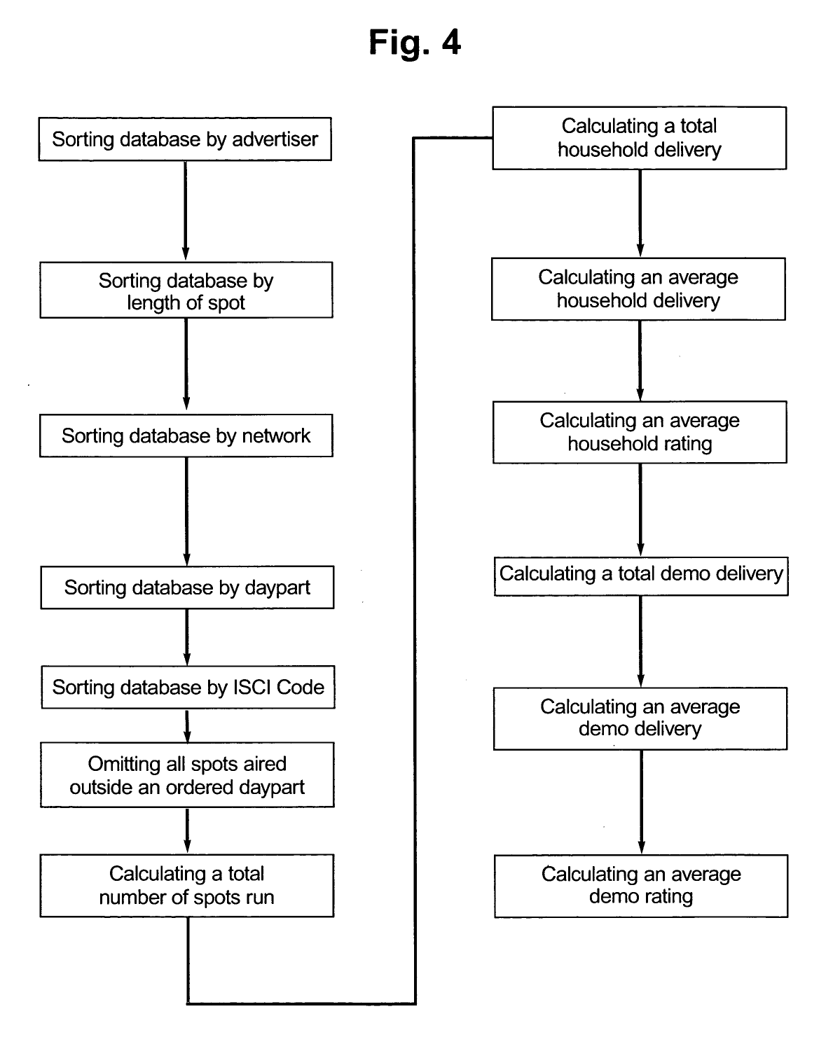

The local spots and their corresponding data (i.e., household delivery, demo delivery) are then aggregated to obtain national equivalent units, which are groups of local spots whose combined subscriber universe equals the claimed delivery universe for the network. For each of these national equivalent units, the number of times the spot aired, the household impressions for the spot, and the demo impressions for the spot are determined. The preferred manner for carrying out this step is illustrated in FIG. 4. To better illustrate this step, a running example will be provided after each part of the step.

To obtain national equivalent unit data, the database is first sorted by advertiser; then, if a particular advertiser has spots of varying lengths, by length of spot; then by network; then, if the advertising schedule included more than one daypart, by daypart; and then, if the schedule included more than a single commercial, by ISCI Code (“Industry Standard Commercial Instructions”—an industry coding standard used to identify commercials). In the example, the database would be sorted first by all Federal Cola spots and then by all spots that aired on Network Sports.

All spots that ran on a given network are identified. For example, all of the Federal Cola spots on Network Sports would be identified. However, all spots that ran outside a contracted daypart are omitted. For example, if Federal Cola contracted for its spots to run between 6 AM and Noon, a spot that ran at 5 PM would not be included in the aggregating of local spots because this spot did not fall within the advertiser's contracted schedule.

Several calculations are then performed to obtain a total number of national equivalent spots and an impression delivery for those spots. The impression delivery for the national equivalent spot includes one or more of: a total household delivery; an average household delivery per spot; an average household rating, which is the average household delivery expressed as a percent of the household universe; a total demo delivery; an average demo delivery per spot; and an average demo rating, which is the average demo delivery expressed as a percent of the demographic universe. These numbers are then subtotaled by ISCI code, by daypart, by length, and by network.

The total number of national equivalent units is calculated by adding up all of the household zone universe numbers for local spots stored in the database for that network and dividing that number by the total number of subscribers claimed in the proposal to the advertiser for that network. For example, the intermediary, Company T, claimed 25 million subscribers in its proposal to Federal Cola. There are four cable systems in the database: Local Guys Cable, Local Gals Cable, Hometown Boys Cable and Hometown Girls Cable. Local Guys Cable has 10 zones with an average universe of 100,000 subscribers per zone; Local Gals Cable has 20 zones with an average subscriber universe of 250,000; Hometown Boys Cable has 10 zones with an average subscriber universe of 1.25 million subscribers; and Hometown Girls Cable has 20 zones with an average subscriber universe of 325,000. The total subscribers for all zones equals the 25 million subscribers that Company T claimed on its proposal. In this example, it is assumed that every zone has the same number of subscribers as the average for the system, and that every spot that ran in every zone delivered the same viewing levels relative to total subscribers as the example spot from Paragraphs [0035] and [0036]. That spot ran in a zone on Local Guys and delivered 1,000 households (or “HH”). That spot in a zone on Local Gals would deliver 2,500 HH; in a zone on Hometown Boys would deliver 12,500 HH; and in a zone on Hometown Girls would deliver 3,250 HH. The total, as this example continues, is that Local Guys Cable ran 20 spots in each of its 10 zones (with 100,000 subscriber homes assigned to each as noted above); Local Gals Cable ran 40 spots in each of its 20 zones (with 250,000 subscriber homes each); Hometown Boys Cable ran 30 spots in each of its zones (with 1.25 million subscriber homes each); and Hometown Girls ran 20 spots in each of its zones (with 325,000 subscriber homes each). The total of the zone universes for all the spots is 725 million subscribers. Company T claimed 25 million subscribers in its proposal. Dividing the total of the zone universes (725 million) by the number of subscribers claimed (25 million) yields the number of national equivalent units delivered. In this example, that number is 29.

The average household delivery per spot is calculated by dividing the total household delivery by the total number of network equivalent spots. Although the number of spots has been calculated, the total household delivery has not yet been calculated. The total household delivery for Local Guys Cable is the spot's household delivery (1,000, as calculated in Paragraph [0035]) for each spot in each zone added together. In this example, the total household delivery is the spot delivery for each spot (1,000) times the number of spots per zone (20) times the number of zones (10), which is 200,000. In the real world, the delivery of every spot is different, and the number of spots per headend is not uniform, so the calculation is an addition calculation rather than the multiplication operation used here. In this example, the total household delivery for the schedule is 7.25 million households. That total is divided by the number of network equivalent units (in this case, 29, as calculated in paragraph [0042]) to get the average delivery per unit which, in this example, is 250,000.

The average household rating is the average household delivery expressed as a percentage of the total number of claimed subscribers. This number is calculated by dividing the average household delivery per spot by the total number of claimed subscribers and then multiplying that number by 100. In the example, the average household rating is 250,000 (average household delivery per spot) divided by 25 million (the number of claimed subscribers) multiplied by 100, or 1 rating (1%).

A substantially similar process is then used to get the total demo delivery, the average demo delivery, and the average demo rating. The total demo delivery delivered by a daypart on the network is calculated by adding up all of the demo delivery numbers for the local spots from the database. The average demo delivery per spot is calculated by dividing the total demo delivery by the total number of network equivalent spots. The average demo rating is the average demo delivery expressed as a percentage of the total number of claimed subscribers multiplied by the demo universe factor that was calculated in FIG. 3 (Paragraph [0032]) and set aside until now.

The steps illustrated in FIGS. 3 and 4 are then repeated for additional spots, as may be necessary.

After accurate impression delivery data has been calculated for each local spot, the data may then be used in numerous ways. For example, the data may be used to perform market research, to calculate the amount due to a cable system or systems for running the spot or spots, to calculate the monies to be charged to an advertiser, and so on. Not only can the data generated by the method be used to generate different outputs, even within a given output the data may be manipulated to accommodate differing demands of different parties.

For example, in the context of using the data to calculate payments to a cable system, Local Guys Cable may want payment based on households who saw a Federal Cola spot that aired on several of Local Guys Cable networks. It may want the payment broken out line by line for each network that aired the spot. In contrast, Local Gals Cable may want payment based on a specific demographic group who a saw at least one of the two or more Federal Cola spots that aired on several of Local Gals Cable networks. Or, it may simply want a lump sum payment for all of the Federal Cola spots, without the line-by-line analysis. Because the invention calculates and stores all of the network and delivery data, the invention can easily accommodate the demands of both Local Guys Cable and Local Gals Cable.

In the context of calculating the amount to be charged to an advertiser, the flexibility of the invention accommodates demands of different advertisers. For example, Federal Cola may be a product that transcends age and sex demographics. Federal Cola, therefore, would care only about how many households saw its spot and not about specific demographic groups. It would thus set up its billing arrangements based on household delivery. In contrast, National Videogame Inc. (NVI) may sell a product that has a specific age and sex demographic, such as males under 18. NVI, therefore, would care only about how many males under 18 saw its spot. It would not care if a 65-year-old woman or a 42-year-old man saw the spot. It would thus set up its billing arrangements based on demo delivery, specifically males under 18, and not household delivery.

The invention provides flexibility to market researchers, cable systems, advertisers, and any other party desiring the data generated by the method, no matter how each of the parties use the data generated by the method.

It will be appreciated by those skilled in the art that the present invention may be practiced in various alternate forms and configurations. The previously detailed description of the disclosed methods is presented for clarity of understanding only, and no unnecessary limitations should be implied there from.

1. A method of calculating a local delivery of a local television commercial spot for a non local advertiser comprising the steps of:
determining an estimated audience delivery for the local spot;
receiving and processing affidavits, in electronic format, for each airing of the local spot, the affidavits comprising detailed information on the airing of the local spots including a date and time the local spot aired;
obtaining national audience measurement data for each time interval during which the local spot aired; and
calculating an actual proportional delivery for the local spot by combining the audience measurement data for each airing of the local spot.

2. A method of aggregating local spots on a network into national equivalent units comprising the steps of:
obtaining, in electronic format, details on the airing of the local spots;
obtaining national viewing data for the network;
determining an impression delivery for the local spots based on the national viewing data;
assigning audience values for the local spots based on the impression delivery for the spots;
aggregating the audience values to create a national equivalent unit on the network.

3. A method for aggregating local commercial spot inventory into national equivalent units for a network and providing accurate audience delivery measurements using published national viewing data comprising the steps of:
processing affidavits in an electronic format for every local spot aired, the affidavits comprising detailed information on the airing of the local spots;
determining an impression delivery for the local spots aired based on viewing data from a national audience measurement and matching the impression delivery with the information from the processed affidavits;
assigning audience values for the local spots based on the impression delivery;
aggregating the local spot affidavit information, impression delivery and audience values to generate a national equivalent unit;
for the national equivalent unit determining the number of times the unit aired and an impression delivery for the unit;
comparing the estimated delivery with the actual delivery to determine the value of the national equivalent unit;
for additional national equivalent units, repeating the steps of determining an impression delivery of the local spots, of assigning audience values for the local spots, and of determining the number of national equivalent units aired and the impression delivery for the national equivalent units; and
calculating from the national equivalent units the amount to charge an advertiser for an advertising schedule on the network.

4. The method of claim 3 wherein the affidavits comprise the exact date and time the local spot aired, the network on which the local spot aired, and the program during which the local spot aired.

5. The affidavits of claim 4 wherein the affidavits are received in electronic format.

6. The method of claim 5 wherein the electronic formats of the affidavits are converted into a readable format.

7. The method of claim 4 wherein the affidavits are received in paper format.

8. The method of claim 7 wherein the paper affidavits are scanned or otherwise converted into a readable electronic format.

9. The method of claim 4 wherein the affidavits are received in both paper and electronic format.

10. The method of claim 3 wherein the steps of calculating the amount to charge an advertiser are repeated for additional networks.

11. The method of claim 10 wherein the method is repeated for additional advertisers.
